(19) United States
(12) Patent Application Publication
(10) Pub. No.: US 2009/0109798 A1
(43) Pub. Date: Apr. 30, 2009

(54) Events recordation device, system and method for caregivers

(76) Inventors: Kathryn West, Suffolk, VA (US); Kirsten Knull, Alexandria, VA (US)

Correspondence Address: MAIER & MAIER, PLLC, 1000 DUKE STREET, ALEXANDRIA, VA, 22314, US

(21) Appl. No.: 12/078,005

(22) Filed: Mar. 26, 2008

Related U.S. Application Data
(60) Provisional application No. 60/983,324, filed on Oct. 29, 2007.

(51) Int. Cl. G04B 47/00; G04F 10/00

(52) U.S. Cl. 368/10; 702/177

(57) ABSTRACT

In accordance with at least one exemplary embodiment, an events recordation device, system and method is disclosed. The events recordation device can include an electronic module having a microprocessor, memory, and a display operatively connected. More than one data entry mechanism can be connected to and can form part of the electronic module for entering data. A first mode of operation can be configured to record and display feeding events data. A second mode of operation can be configured to record and display medication events data. A third mode of operation can be configured to record and display sleep events data.

### CROSS REFERENCE TO RELATED APPLICATIONS

This application claims priority, under 35 U.S.C. § 119(e), to U.S. Provisional Patent Application Ser. No. 60/983,324, filed Oct. 29, 2007, the disclosure of which is incorporated by reference herein in its entirety.

### BACKGROUND

Caregivers, such as biological and non-biological parents, guardians, childcare providers, medical personnel and the like, typically have a range of responsibilities they must regularly attend to for infants. These responsibilities include several types of events that should be carried out periodically to maintain the comfort and health of infants. Periodic events include breast and/or bottle feeding, the administration of any medications, and sleep events (e.g., naps) to maintain and bolster the comfort and health of infants under the caregivers' care. Scheduling for such events typically require strict timelines or less strict timelines. For example, medications are usually administered under the directions of physicians and are recommended to be done so in strict accordance therewith. Feeding and sleep events typically have a greater degree of flexibility in when they should periodically occur.

Organization is often seen as paramount to providing quality infant care. Because periodic events, if missed or delayed, are likely to adversely affect the comfort and/or health of infants, it has almost been universally recommended by childcare professionals that such events be scheduled, recorded and logged. Nevertheless, the demands of infant care typically compete with other demands and interests of caregivers. Indeed, quality infant care, whether by parents or others, remains challenging. While organization is often needed in meeting the challenges, staying organized provides its own set of challenges.

### SUMMARY

According to at least one exemplary embodiment, an events recordation device for caregivers is disclosed. The events recordation device can include an electronic module having a microprocessor, memory, and a display operatively connected. More than one data entry mechanism can be connected to and can form part of the electronic module for entering data into the electronic module. A first mode of operation for the electronic module can have one or more display screens. The first mode of operation can be configured to record and display feeding events data.

In another exemplary embodiment, a method of operation for an events recordation device is disclosed. The method can include providing a first mode of operation in response to one or more mode selections; recording a feeding start time in response to a commencement selection of a data entry mechanism corresponding to one of a right breast feeding, a left breast feeding and a bottle feeding; recording a feeding method in response to the commencement selection of the data entry mechanism; recording a feeding end time in response to a cessation selection of the data entry mechanism; and displaying feeding events data in response to at least one of, the one or more mode selections, the commencement selection and the cessation selection.

In yet another exemplary embodiment, a second mode of operation can have one or more display screens. The second mode of operation can be configured to record and display medication events data. In a further exemplary embodiment, a third mode of operation can have one or more display screens. The third mode of operation can be configured to record and display sleep events data.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 is a front view of an exemplary events recordation device.

FIG. 2 is a side view of the exemplary events recordation device of FIG. 1.

FIG. 3 is a rear view of the exemplary events recordation device of FIG. 1.

FIG. 4 is a front view of another exemplary events recordation device.

FIG. 5 is an exploded view of yet another exemplary events recordation device.

FIG. 6 is a front view of still another exemplary events recordation device.

FIG. 7 illustrates an exemplary display screen of an exemplary electronic module for a mode of operation.

FIG. 8 illustrates another exemplary display screen of an exemplary electronic module for another mode of operation.

FIG. 9 illustrates yet another exemplary display screen of an exemplary electronic module for yet another mode of operation.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the invention include the discussed feature, advantage or mode of operation.

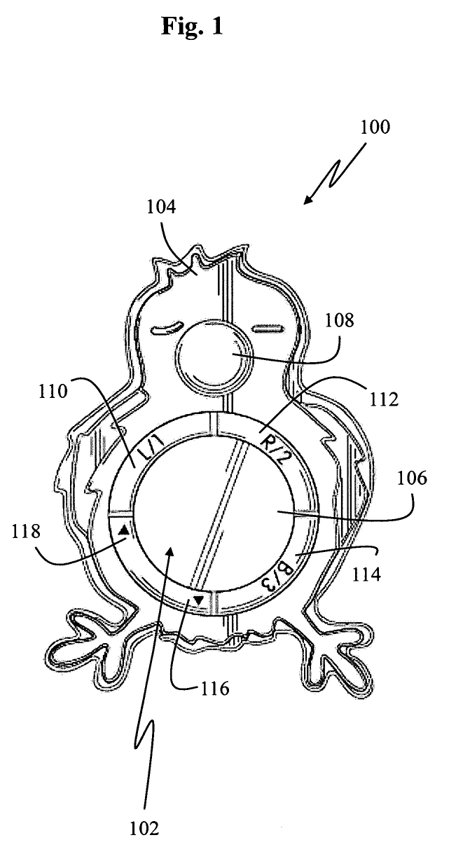

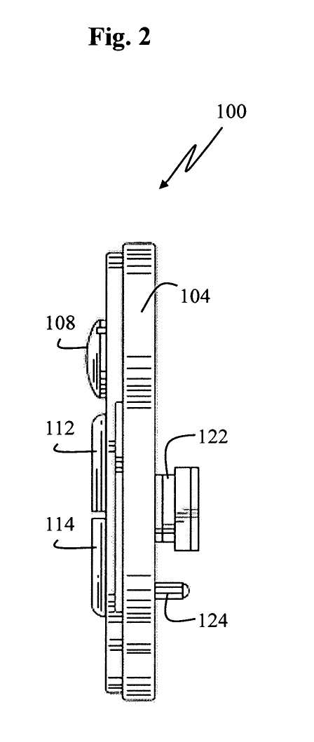

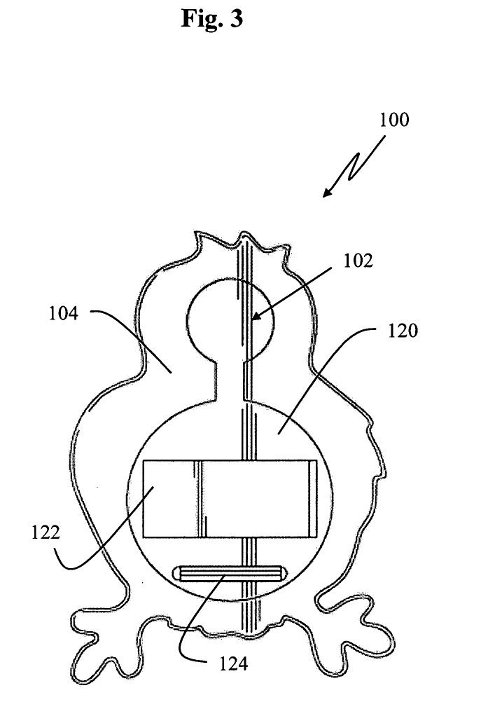

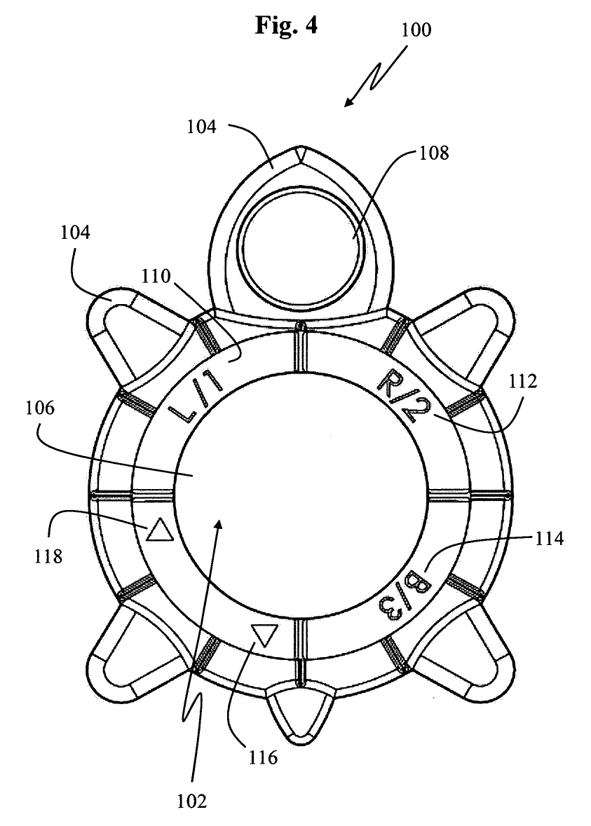

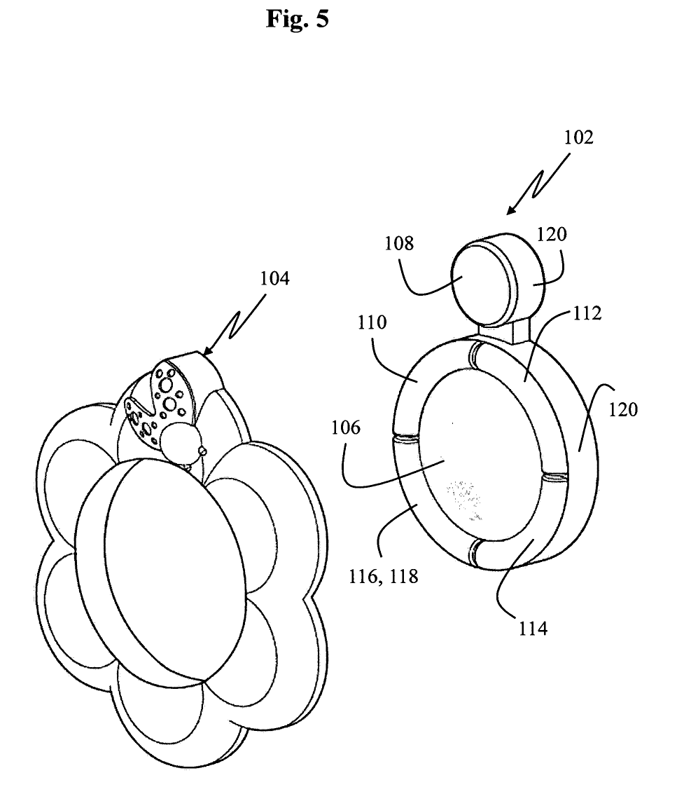

Referring to FIGS. 1-6, exemplary events recordation device 100 for caregivers is shown in accordance with at least one exemplary embodiment. Each events recordation device 100 can include electronic module 102. Electronic module 102 can be received by housing 104. In at least one exemplary embodiment, electronic module 102 can be removably received by housing 104. Accordingly, different housings 104 can be used to receive electronic module 102. For example, different housings 104 may be needed as replacements and/or to optionally provide a caregiver with differing ornamental housing features. In other embodiments, electronic module 102 can be securely and non-removably received by housing 104.

Electronic module 102 can include a microprocessor, memory (volatile and/or non-volatile) and, optionally, a power source, among other elements known to one having ordinary skill in the art. Electronic module 102 can also include display 106. Electronic module 102 can further include one or more data entry mechanisms and circuitry associated therewith. The microprocessor, memory, an optional power source, display 106, data entry mechanisms and any other elements can be operatively connected.

The data entry mechanisms can allow a caregiver to operate electronic module 102. The data entry mechanisms, as a whole, can provide selection functionality, mode toggle functionality, commencement/cessation functionality, scrolling/review functionality, alphanumeric data entry functionality and the like known to one having ordinary skill in the art. In at least one exemplary embodiment, data entry mechanisms can include mode button 108, first (e.g., “L/1” of “Left”) button 110, second (e.g., “R/2” or “Right”) button 112, third (e.g., “B/3” or “Bottle/Save”) button 114, down (e.g, v) button 116 and up (e.g., ̂) button 118. In at least one other embodiment, data entry mechanism can include a pointing device (e.g., a mouse), keyboard, touch screen and the like known to one having ordinary skill in the art.

Elements of electronic module 102 can be organized within casing 120. Casing 120 can be constructed of various plastic materials known to one having ordinary skill in the art, as non-limiting examples. Casing 120 may be durable and child safe. Buttons 108, 110, 112, 114, 116, 118 can be exposed for caregiver operation. Display 106, or at least the viewable portion thereof, can be situated so as to be viewable by a caregiver. The microprocessor and memory can be contained and shielded from the outside environment by casing 120.

A power source, such as any conventional battery, can also be contained by casing 120 and may or may not be accessible to a caregiver for any needed replacement. Alternatively, singularly or in conjunction, a port for connecting to an outside power source can be provided. For example, a port can be provided for connecting a power plug that mates with a power socket of a commercial power supply. In at least one exemplary embodiment, electronic module 102 may be connected to an outside power source, for charging an onboard power source, such as a conventional battery. Other embodiments may rely on renewable energy sources, such as solar power, alone or in combination with other power sources.

In at least one exemplary embodiment, a serial or parallel port(s), such as a USB port, can be included with electronic module 102. The port can be exposed through casing 120. The port can be used to connect electronic module 102 to a computing device for downloading/uploading data, a removable memory device (e.g., a Flash drive), a printer and the like. For example, the port can be used to download data to a software program with personalization features or to a more generic spreadsheet application stored on a computing device via a USB port and USB cable connecting electronic module 102 to a computing device. For example, the software program can be personalized by infant data, such as picture(s), name, birth date and the like. Also, electronic module 102 can make use of wireless technologies, such as BLUETOOTH, WiFi and the like, for transmitting data to a computing device.

In at least one exemplary embodiment, the microprocessor and memory can be provided by a microcontroller, as is known to one having ordinary skill in the art. Numerous microcontrollers are commercially available and can be selected by one having ordinary skill in the art for use with events recordation device embodiments. In addition to the conventional arithmetic and logic elements of a conventional general-purpose microprocessor, microcontrollers integrate additional elements, such as read-write memory for data storage, read-only memory, input/output interfaces, timers, drivers and the like. In a non-limiting manner, volatile memory can include RAM for data storage. In a non-limiting manner, non-volatile memory can include ROM, EPROM, EEPROM and Flash memory for program and operating parameter storage. In at least one exemplary embodiment, a microcontroller can include a LCD driver. Accordingly, in at least one exemplary embodiment, display 106 can be a LCD display. Alternatively, display 106 can be any other display known to one having ordinary skill in the art.

In at least one exemplary embodiment, casing 120 of electronic module 102 can have one or more fastening mechanisms 122 and/or one or more attachment mechanisms 124. For example, fastening mechanism 122 can be a clip on the backside of electronic module 102. Clip 122 may be used to fasten events recordation device 100 to an infant's clothing, a caregiver's clothing, a carrying bag (e.g., diaper bag) and like items that can be put into a securing relationship with clip 122. Also, alone or in combination, attachment mechanism 124 can be provided on the backside of be a loop. Various accessory items can be coupled to electronic module 102 by means of loop 104. For example, one end of band 126 can be threaded through and secured around loop 124. At the other end of band 126, an item, such as pacifier 128, can be attached.

Electronic module 102 can be provided in various designs and configurations, as will be readily recognized by one having ordinary skill in the art. As shown in a non-limiting manner, electronic module 102 and casing 120 thereof can be provided with a major substantially circular portion and a minor substantially circular portion radially projecting therefrom. On the minor portion, mode button 108 can be provided. On the major portion, display (or at least a viewable portion thereof) can be substantially circular or framed so as to appear substantially circular. Buttons 110, 112, 114, 116, 118 can be in a circumferential relationship with display 106. Buttons 108, 110, 112, 114, 116, 118 can be labeled with any combination of numerals, letters, characters and the like, and may be done so that a caregiver may distinguish between them.

Display 106 may be illuminated in order to view display 106 in low-light conditions. An illuminated display 106 may also serve to allow for increased ease in locating electronic module 102 in low-light conditions. All or less than all of buttons 108, 110, 112, 114, 116, 118 may be backlit in order to increase visibility and ease of location in low-light conditions.

Electronic module 102 can be received by housing 104. Buttons 108, 110, 112, 114, 116, 118 can be exposed for caregiver operation. Display 106, or at least the viewable portion thereof, can be situated so as to be viewable by a caregiver. Housing 104 can be constructed of various plastics, rubbers and like materials known to one having ordinary skill in the art. For example, housing 104 can be made of a soft, pliable plastic teething material. In at least one exemplary embodiment, housing 104 may be made of food grade polyurethane. As such, housing 104 may be top-rack dishwasher safe.

Housing 104, as a whole or in part, can have one or more ornamental features. Housing 104 can be designed and shaped to be aesthetically-pleasing to infants and/or caregivers. Housing 104 can also be designed and shaped to appear comical, whimsical, commercial and the like. One ornamental theme for housing 104 can include various animal and plant shapes. As shown in a non-limiting manner, housing 104 can be designed and shaped to resemble a chick, a turtle or a flower with a ladybug. As another non-limiting example, housing 104 can be designed and shaped to resemble a bee.

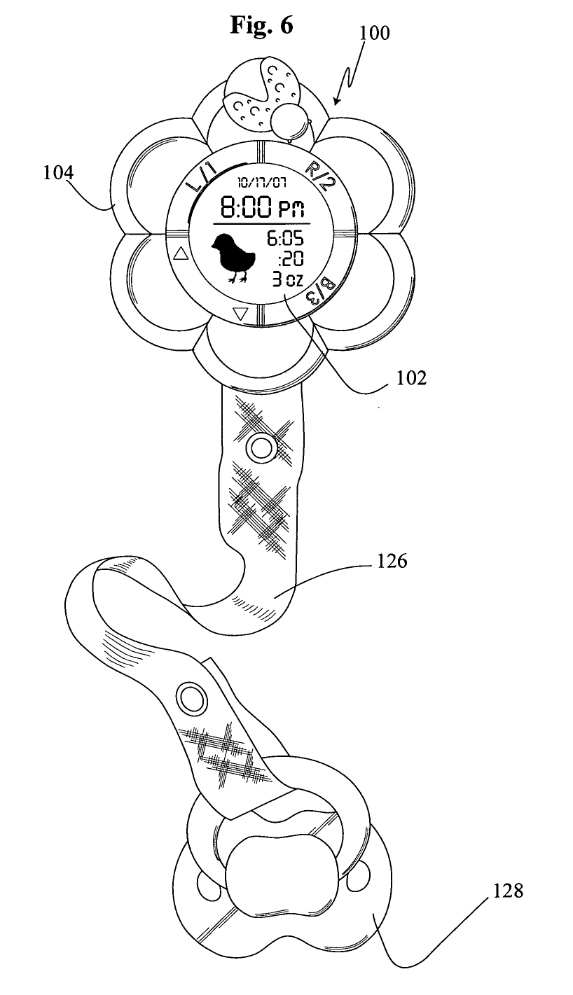

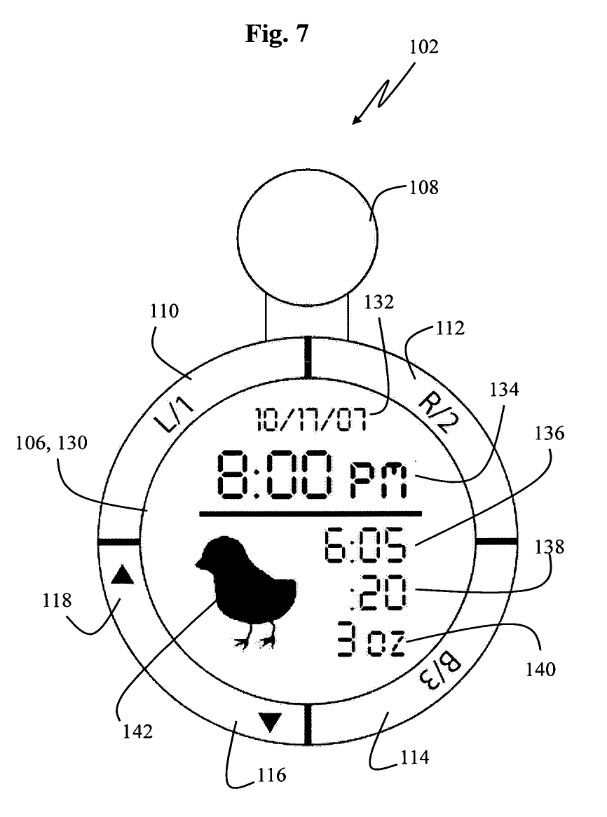

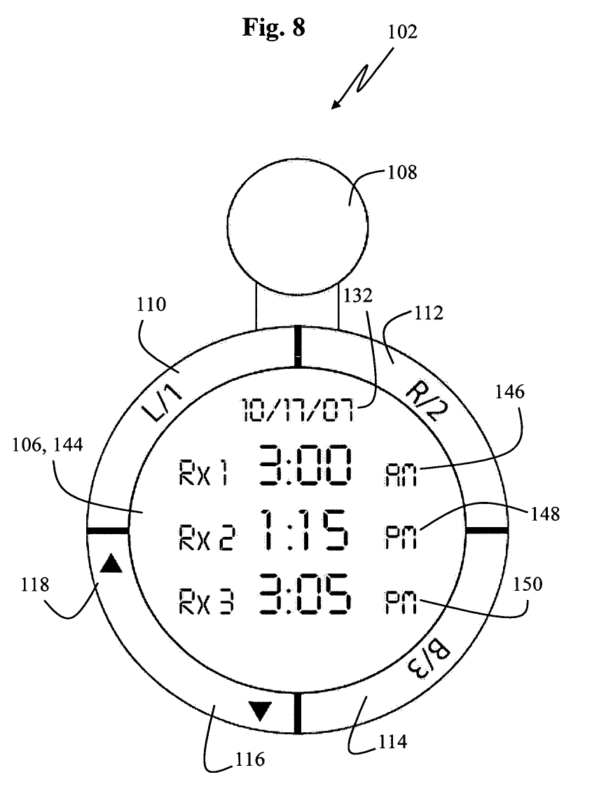

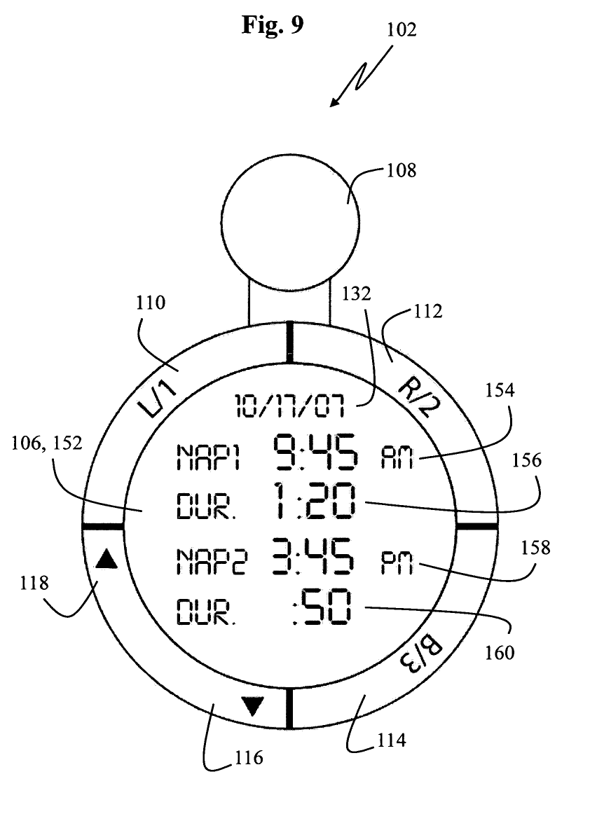

With particular reference to FIGS. 6-9 for illustrative purposes and in a non-limiting manner, the following description is primarily directed to operating an exemplary events recordation device, such as events recordation device 100. It is contemplated that operation of events recordation device 100 may be primarily carried out by caregivers, such as biological and non-biological parents, guardians, childcare providers, medical personnel and the like. Events recordation device 100 can have one or more modes of operation. Each mode of operation can have one or more display screens associated therewith. Exemplary modes of operation and associated display screens are described below in an illustrative and non-limiting manner, as one of ordinary skill in the art will readily recognize various alternatives for practicing embodiments.

Mode button 108 can be used to toggle through more than one mode of operation by a caregiver. For example, if a first mode of operation is being displayed by display 106, then one selection of mode button 108 can toggle to a second mode of operation. Successive selections of mode button 108 can toggle to successive modes of operation until the last mode of operation is reached, in which another selection of mode button 108 can return to the first mode of operation in a looping manner.

In a first mode of operation that can be directed to infant feeding events, one of first button 110, second button 112 and third button 114 can be selected by a caregiver indicating a commencement of a feeding event. For example, first button 110 can be selected to signal the commencement of a left breast feeding event. Second button 112 can be selected to signal the commencement of a right breast feeding event. Third button 114 can be selected to signal the commencement of a bottle (or other delivery vessel) feeding event. Electronic module 102 can record the start time of the feeding event and which manner of delivery (i.e. left breast, right breast or bottle) is being used.

In at least one exemplary embodiment, one of first button 110, second button 112 and third button 114 can be pressed and held for a predetermined time period (e.g., three seconds) to signal the beginning of a feeding event. In some selections, press-and-hold selection may serve to lessen accidental data entry. Simple press selections may be more appropriate in other selection contexts throughout modes of operation for events recordation device 100. In at least one exemplary embodiment, as shown, “L/1”, “R/2” and “B/3” may be used to designate first button 110, second button 112 and third button 114, respectively, for modes of operation. In another exemplary embodiment, “Left”, “Right” and “Bottle/Save” may be used.

The same one of first button 110, second button 112 and third button 114 can be selected by a caregiver to indicate a cessation of the feeding event. Electronic module 102 can record the end time of the feeding event within its memory. In at least one exemplary embodiment, first button 110 and second button 112 corresponding to left and right breast feeding events, respectively, can be pressed and held for a predetermined time period (e.g., three seconds) to signal the end of the feeding event.

Also, in at least one exemplary embodiment, third button 114 can be pressed one or more times to set a measurable amount of formula or breast milk given during the bottle feeding event, and can be pressed and held for a predetermined time period (e.g., three seconds) to signal the measurable amount to record and the cessation of the bottle feeding event. The first selection or last selection (e.g., pressed and held) may be used by electronic module 102 to determine the end time of the bottle feeding event. Alternatively, in at least one other embodiment, down button 116 and up button 118, whether alone or in cooperation, can be used to enter the measurable amount before and/or after button 114 is selected to end the bottle feeding event. Using start and end times or any other timing mechanism, electronic module 102 can determine the duration of a right breast, a left breast or a bottle feeding event.

In the first mode of operation, exemplary display screen 130 of display 106 can present a variety of information to a caregiver before, during and after feeding events. For example, display screen 130 can present, when appropriate, present date 132, present time 134, feeding start time 136, feeding duration 138, measurable amount 140 (e.g., in ounces) and breast indicating graphical icon 142. After a feeding event, feeding start time 136, feeding duration 138, any measurable amount 140 and any breast indicator 142 can reference the last feeding event recorded.

Graphical icon 142 can be any of a variety of icons known to and selectable by one having ordinary skill in the art. As shown and in a non-limiting manner, graphical icon 142 can resemble a chick. Before and/or after a feeding event, graphical icon 142 can indicate which breast was previously used, or, alternatively, which breast is scheduled for next use by, for example, pointing (e.g., the chick facing) in the left or right direction. Also, graphical icon 142 may indicate which breast is currently being used during a feeding event. The direction indicated can be in response to a commencement and/or cessation selection of first button 110 and/or second button 112.

In the first mode of operation, down button 116 and up button 118, alone or in cooperation, can be used to review previously recorded and logged data referencing previous feeding events. For example, buttons 116, 118 can be used to scroll through stored feeding events presented on one or more display screens. Electronic module 102 can store a predetermined number of previous feeding events or can allocate a predetermined amount of memory to storing previous feeding events. Alternatively, electronic module 102 can store a practically unlimited number of feeding events. Previous feeding events can be reviewable by a caregiver through selections of buttons 116, 118. Feeding events can be continuously recorded, or, alternatively, continuously rewritten by electronic module 102 in response to more recent feeding events. Stored feeding events can be presented to a caregiver on one or more display screens where each display screen can display various information, such as feeding date (or, singularly or in conjunction, day of the week), present date, feeding start time, feeding duration, any measurable amount for bottle feedings and indication of breast used for breast feedings and the like known to one having ordinary skill in the art.

In a second mode of operation that can be directed to the administration of one or more medications (whether, for example, prescribed or over-the-counter medications), one of first button 110, second button 112 and third button 114 can be selected by a caregiver indicating an administration time for a first medication, a second mediation and a third medication, respectively. In at least one exemplary embodiment, one of first button 110, second button 112 and third button 114 can be pressed and held for a predetermined time (e.g., three seconds) to signal the administration of the respective medication. Accordingly, first button 110 can be selected to signal the administration of any first medication. Second button 112 can be selected to signal the administration of any second medication. Third button 114 can be selected to signal the administration of any third medication. Electronic module 102 can, thus, record the clock time for the administration of up to three medications. In other embodiments, the number of permissible medications for recording administration times can be more or less than three.

For example, in embodiments recording more than three medications, more buttons can be included on electronic module 102, or, buttons 116, 118 can be used to scroll to the appropriate medication entry and at least one of first button 110, second 112 and third button 114 can be selected to signal the administration of the selected medication. In at least one exemplary embodiment, third button 114 can be selected to signal the administration of the selected medication. Also, in at least one exemplary embodiment, the number of medication entries available for selection can be six, but is not so limited. Electronic module 102 may also record any other appropriate data, as will be readily recognized to one having ordinary skill in the art.

In the second mode of operation, exemplary display screen 144 of display 106 can present a variety of information to a caregiver regarding medication events. For example, display screen 144 can present, when appropriate, present date 132, last administration time 146 of first medication, last administration time 148 of a second medication and last administration time 150 of a third medication. In at least one exemplary embodiment, each of last administration times 146, 148, 150 can be rewritten and updated upon entrance of the most recent administration time of the corresponding medication by a caregiver. In at least one other exemplary embodiment, administration time for more than three medications can be displayed by a display screen (not shown). For instance, administration times for six medications can be displayed.

Also, in at least one other exemplary embodiment, electronic module 102 can include an alarm mechanism. In the second mode of operation, the alarm mechanism can be separately set for each medication. In such embodiments, a display screen (not shown), which may be similar to display screen 144, can present both the last administration time and the next scheduled administration time for each medication. Thus, each medication can have two clock times associated therewith. Smaller fonts can be used to accommodate presenting the additional information on the display screen, as will be readily recognized by one having ordinary skill in the art. The next schedule administration time can be directly set by a caregiver or calculated based on an interval (or other repeatably calculable schedule) set by a caregiver operating electronic module 102. The display can also have a visual indicator showing that an alarm (alert) has been set for one or more medications. As one non-limiting example, a medication with a next scheduled administration time can be presented in an inverted color scheme (e.g., lighter alphanumeric characters against a darker surrounding background as opposed to darker alphanumeric characters against a lighter surrounding background). The alarm can be a sound, visual, vibrating or like alert and any combination thereof.

Referring again to exemplary display screen 144, before the recording of one or more administration times for a particular medication, identification data for each medication can be entered on and displayed by electronic module 102 as opposed to more generic designations (which may instead be used by default or solely by some embodiments), such as “Rx1”, “Rx2”, and “Rx3”. In at least one exemplary embodiment, a setup mode of operation can be provided for entering identification for each medication. The setup mode can also be used to set the present time, present date (or, alternatively, singularly or in conjunction, present day of the week) and the like known to one having ordinary skill in the art. The setup mode can also display instructions for entering various types of data into electronic module 102. A display screen for entering identification data for medications can be prompted for in the setup mode and can be selected by the user by selecting one of first button 110, second button 112 and third button 114. In at least one exemplary embodiment, second button 112 can be prompted for and selected in the setup mode in order to reach the display screen for entering identification data for medications.

At the display screen for entering identification data for medications, for example, down button 116 and up button 118, alone or in cooperation, can be used to toggle/scroll through alphanumeric characters for selection in providing identification data. For instance, in entering identification data for a first medication, buttons 116, 118 can be used to highlight the medication name entry. Then, third button 114 (or, alternatively, first button 110 or second button 112 in further embodiments), for example, can be selected to select the medication name entry. A cursor can be provided at the first slot of the medication name entry for accepting a first alphanumeric character. Buttons 116, 118 can be used to scroll through the alphanumeric characters. Third button 114 can be again selected to accept the alphanumeric character. The cursor can then be provided at the second slot of the medication name entry for accepting a second alphanumeric character. At the second slot for accepting the second alphanumeric character, buttons 116, 118 can be used to find a second alphanumeric character through toggling. Then, third button 114 can be selected to accept the second alphanumeric character. This process can be likewise repeated to enter alphanumeric characters up to the amount of slots provided. In at least one exemplary embodiment, the amount of slots provided may be three (as shown), less than three or more than three. In at least one other exemplary embodiment, scheduled administration times for each medication can be similarly programmed.

In a third mode of operation that can be directed to sleep (sleeping) events, third button 114 (or, alternatively, first button 110 or second button 112 in further embodiments) can be selected by a caregiver indicating a commencement of a sleeping event (e.g., nap), respectively. In at least one exemplary embodiment, the number of recordable and storable sleeping events may be practically unlimited. Electronic module 102 can record the start time for the sleep event selected by the caregiver. In at least one exemplary embodiment, third button 114 (or, alternatively, first button 110 or second button 112 in further embodiments) can be pressed and held for a predetermined time period (e.g., three seconds) to signal the beginning of a sleep event.

Third button 114 (alternatively, the same first button 110 or second button 112) can again be selected by a caregiver to indicate a cessation of the sleep event. Electronic module 102 can record the end time of the sleep event within its memory. In at least one exemplary embodiment, third button 114 (alternatively, first button 110 or second button 112) can again be pressed and held for a predetermined time period (e.g., three seconds) to signal the end of the sleep event. Using start and end times or any other time mechanism, electronic module 102 can determine the duration of the sleep event.

In the third mode of operation, exemplary display screen 152 of display 106 can present a variety of information to a caregiver before, after and during sleep events. For example, display screen 152 can present, when appropriate, present date 132, first sleep event start time 154, first sleep event duration 156, second sleep event start time 158 and second sleep event duration 160. In at least one exemplary embodiment, display screen 152 may also show or scroll to further sleep event start times and sleep event durations.

Also, in at least one exemplary embodiment, down button 116 and up button 118, alone or in cooperation, can be used to review previous sleep events or to find further sleep events to add. For example, buttons 116, 118 can be used to scroll through stored sleep events presented on one or more display screens. In at least one other exemplary embodiment, the number of previous sleep events stored can be practically unlimited. The previous sleep events can be reviewable by a caregiver through selections of buttons 116, 118. Sleep events can be continuously recorded or, alternatively, continuously rewritten by electronic module 102 in response to more recent sleep events.

Referring to other exemplary embodiments, electronic module 102 can be programmed to be used as a stopwatch and provided with stopwatch functionality. An events recordation device can be programmed and tailored for elderly users, and can assist, for example, in tracking meals, diet supplements, medications and the like. A wristwatch version of an events recordation device can be offered. A stationary clock design can be offered including additional features, of an alarm clock, radio, music player and the like. The above described features can be programmed into a portable device, such as a PDA, mobile phone and the like, and may make use of wireless technologies such as BLUETOOTH. Infant monitoring features can be included for events recordation devices, which, for example, can transmit sound, video and/or the like to alert parents to infant activities, such as infant vocalizations. Various other features and housing types will be readily recognized to one having ordinary skill in the art having the benefit of this disclosure.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An events recordation device for caregivers, comprising:
an electronic module having a microprocessor, memory, and a display operatively connected;
more than one data entry mechanism connected to and forming part of the electronic module for entering data into the electronic module; and
a first mode of operation for the electronic module, the first mode of operation having one or more display screens, the first mode of operation configured to record and display feeding events data.

2. The device of claim 1, further comprising:
a second mode of operation for the electronic module, the second mode of operation having one or more display screens, the second mode of operation configured to record and display medication events data.

3. The device of claim 1, further comprising:
a third mode of operation for the electronic module, the third mode of operation having one or more display screens, the third mode of operation configured to record and display sleep events data.

4. The device of claim 1 wherein the feeding events data includes at least one of a start time of a feed, a duration of a feed, a measurable amount of a feed and a left/right breast indicator.

5. The device of claim 2 wherein the medication events data includes at least one administration time of at least one medicine.

6. The device of claim 2 wherein the second mode of operation is configured to record and display medication identifying data.

7. The device of claim 3 wherein the sleep events data includes timing data for at least one sleep event, the timing data is at least one of a start time and a duration of the at least one sleep event.

8. The device of claim 1, further comprising:
a toggle mechanism for toggling between more than one mode of operation.

9. The device of claim 1 wherein the more than one data entry mechanism includes a plurality of data entry buttons in a circumferential relationship with a substantially circular display.

10. The device of claim 8 wherein the toggle mechanism is a toggle button in a radial relationship with a remainder of the electronic module, the remainder of the electronic module being substantially circular.

12. The device of claim 1, further comprising:
a port on the electronic module for connecting to another device.

13. The device of claim 1, further comprising:
a housing receiving the electronic module.

14. The device of claim 13 wherein the housing is constructed, at least in part, from a soft plastic material.

15. The device of claim 13 wherein the housing is constructed, at least in part, from a food grade polyurethane.

16. A method of operation for an events recordation device, comprising:
providing a first mode of operation in response to one or more mode selections;
recording a feeding start time in response to a commencement selection of a data entry mechanism corresponding to one of a right breast feeding, a left breast feeding and a bottle feeding;
recording a feeding method in response to the commencement selection of the data entry mechanism;
recording a feeding end time in response to a cessation selection of the data entry mechanism; and
displaying feeding events data in response to at least one of, the one or more mode selections, the commencement selection and the cessation selection.

17. The method of claim 16, further comprising:
displaying previously logged feeding events data in response to one or more selections of one or more scrolling data entry mechanisms.

18. The method of claim 16, further comprising:
displaying a graphical icon indicating the right breast feeding or the left breast feeding in response to at least one of the mode selection, the commencement selection and the cessation selection.

19. The method of claim 16, further comprising:
providing a second mode of operation in response to one or more mode selections;
recording an administration time for a medicine in response to a selection of a data entry mechanism; and
displaying medication events data.

20. The method of claim 16, further comprising:
providing a third mode of operation in response to one or more mode selections;
recording a sleep commencement time for a sleep event in response to a commencement selection of a data entry mechanism;
recording a sleep cessation time for the sleep event in response to a cessation selection of the date entry mechanism; and
displaying sleep events data in response to at least one of the one or mode selections, the commencement selection and the cessation selection.
